(19) United States
(12) Patent Application Publication
(10) Pub. No.: US 2004/0208545 A1
(43) Pub. Date: Oct. 21, 2004

(54) Optical switch with enhanced flexibility

(76) Inventors: Ali Langari, Toronto (CA); Rob Brennan, Pakenham (CA); Blaine Hobson, King City (CA); Stelio Derventzis, North York (CA); Mike Liwak, Pickering (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/013,495

(22) Filed: Dec. 13, 2001

(51) Int. Cl. G02B 6/26; G02B 6/42; H04J 14/02

(52) U.S. Cl. 398/48; 385/16

(57) ABSTRACT

Disclosed is a novel switching architecture including a dedicated switching path between each pair of ports, the dedicated switching path including a switch for selectively attenuating signals at different wavelengths independently. The architecture supports switching signals having different numbers of channels between ports in an easily upgradable switch architecture.

### FIELD OF THE INVENTION

The invention relates generally to optical signal switching and more particularly to an optical wavelength switch architecture having a high degree of flexibility.

### BACKGROUND OF THE INVENTION

Presently, communication networks are commonplace. One form of data communication is fibre optic communication. In optical communication networks, data is transmitted within an optical signal—a light signal. The data is encoded within a signal at a carrier frequency. The carrier frequency is a single colour of light—a single wavelength. Of course, the carrier frequency need not be in the range of visible wavelengths and is often at longer wavelengths, for example in the 1300 to 1650 nm range.

One component in optical networks is an optical switch. An optical switch provides functionality to allow the switching of an optical signal between one optical path and another optical path. For example, an N×N (N by N) optical switch allows N signal input paths to be selectably coupled to each of N signal output paths. Some switches provide unrestricted switching between the input and output paths—non-blocking switches—and some switches provide only a subset of possible switching configurations—blocking switches.

A common form of optical switch used in optical networking is an optical cross connect. In an optical cross connect, a signal received at any input port is switchably couplable to any output port. Thus a 3×3 optical cross connect provides switching of three signals received at three input ports to three output ports in any of six possible configurations—{(optical path from input port 1 to output port 1), (optical path from input port 2 to output port 2), (optical path from input port 3 to output port 3)}; {(optical path from input port 1 to output port 1), (optical path from input port 2 to output port 3), (optical path from input port 3 to output port 2)}; {(optical path from input port 1 to output port 2), (optical path from input port 2 to output port 1), (optical path from input port 3 to output port 3)}; {(optical path from input port 1 to output port 2), (optical path from input port 2 to output port 3), (optical path from input port 3 to output port 1)}; {(optical path from input port 1 to output port 3), (optical path from input port 2 to output port 2), (optical path from input port 3 to output port 1)}; and {(optical path from input port 1 to output port 3), (optical path from input port 2 to output port 1), (optical path from input port 3 to output port 2)}. The use of a massive cross connect is typically required to support large numbers of input and output ports.

In order to increase the bandwidth capacity of an optical network, a technique called wavelength division multiplexing (WDM) is used. WDM allows different signals to propagate within a same optical path at different carrier frequencies. With different wavelength channels, an approximate multiple of the bandwidth is achievable. A switch that supports WDM signals and independently switches signals within individual wavelength channels is referred to herein and in the claims that follow as an optical wavelength switch.

Unfortunately, prior art optical switching systems require that the signals be divided into their separate wavelength channels prior to switching thereof. For a switch supporting interport switching within 40 wavelength channels, this configuration requires interport switches for each of the 40 wavelength channels, resulting in a large number of switching elements and fibre interconnections between different optical paths and the switching elements.

Referring to FIG. 2, an N×N wavelength switch supporting 4 wavelength channels is shown. When N=4, the prior art shown requires four demultiplexers, one at each of the four input ports, four multiplexers one at each of the four output ports, 16 switching elements for each wavelength channel and hence 16×4=64 switching elements in total, and 8 fibre interconnects for each wavelength channel and hence a total of 4×8=32 fibre interconnects.

Similarly, an 8×8 optical wavelength switch supporting 40 wavelength channels requires 8 demultiplexers one at each of the 8 input ports, 8 multiplexers one at each of the 8 output ports, 64 switching elements for each wavelength channel and hence 64×40=2560 switching elements, and 32 fibre interconnects for each wavelength channel and hence 40×32=1280 fibre interconnects. These large numbers of switches are provided using a massive optical cross connect.

As each wavelength channel requires a wavelength port on each demultiplexer, a wavelength port on each multiplexer, and many switching elements, adding further wavelength channels to an existing switch is costly. In a first approach to performing such an upgrade, multiplexers and demultiplexers with extra available channels and a larger than necessary optical cross connect are installed. This, of course, increases the initial installation costs. Alternatively, since incremental scaling of optical wavelength switches is often quite complicated, another approach is to add a new optical wavelength switch to replace the existing one. This results in higher than needed upgrade costs relating to replaced equipment. Yet another option is to install a new optical wavelength switch in parallel with the existing optical wavelength switch in order to switch different wavelength channels than the existing optical wavelength switch. Thus, each switch operates independently on each of a subset of available wavelength channels. As noted above, such an approach results in unused switch capabilities upon installation increasing the initial costs. Also, signal strength issues and other complications make such an approach less than desirable in many applications.

Similarly, increasing N—adding a port—results in additional costs. If an N×N optical wavelength switch is installed, until N ports are used, there is little cost in adding ports since N is not changed. For example, when N is 5 and only 3 of the ports of the 5×5 switch are being used, a fourth port is usable by merely coupling light in and out of the fourth port of the 5×5 switch. That said, the initial optical wavelength switch already cost an amount relating to the N ports capabilities it has—exceeding the cost and capabilities required at a time of installation. Once an extra port above and beyond N ports is required, the entire switching fabric must be replaced.

For example, upgrading from an 8×8, 40-wavelength channel optical wavelength switch to a 9×9, 40-channel optical wavelength switch is described hereinbelow. To support the new input port and the additional output port, another demultiplexer and another multiplexer are required. Also, for each wavelength channel, 5²−4²=9 new switching elements are necessary, resulting in a need for 40×9=360 new switching elements to support all 40 wavelength channels. Furthermore, a total of 40×(2×5−2×4)=80 new interconnects are necessary outside of the optical cross connect itself. Adding new ports to the optical wavelength switches of the prior art in an incremental fashion is, therefore, a laborious and complex task. Of course, the above does not even touch on the reliability issues surrounding such an incremental upgrade where an optical wavelength switch has 360 new switching elements and 80 interconnects installed in the field without resources for complete and adequate testing thereof. In many situations, it is better to upgrade the prior art optical wavelength switches with replacement optical wavelength switches supporting the increased functionality desired.

1×2 optical switching elements are well known in the art. 1×2 mechanical switches actuate in a mechanical fashion to divert a beam of light between a first and second port to propagating from the first port to a third other port. For example, this is sometimes accomplished using a movable mirror for deflecting the beam of light and disposed between the ports. Another approach to optical switching involves integrated devices without moving components. In U.S. Pat. No. 5,528,710 in the name of Burton is described a set of couplers, or splitters, connected to an active waveguide substrate producing a switch. Such an N×N switch provides the core functionality for switching signals within a single same wavelength channel. Such an integrated device facilitates mass production of the switching elements; unfortunately, scalability of multichannel switches remains problematic. Further, the device of Burton requires replacement for upgrading thereof

In U.S. Pat. No. 5,627,925 in the name of Alferness is described a network architecture that includes wavelength converters within a switch. This allows for switching of signals within a switch to other wavelength channels. Thus, signals within a wavelength channel are switchable to other optical paths via switching as well as to other wavelength channels through wavelength switching.

Recently, a lot of attention has been focused on the optical backplane concept. Analogous to electrical backplanes, the optical backplane allows installation and removal of components with ease. Such optical backplanes will greatly facilitate optical switch upgrades. For example, increasing the channel count in a prior art switch merely requires pulling out each muliplexer/demultipler board—port interface boards—and replacing same with interfaces that support higher channel counts. Then, switches for the additional channels are inserted into their respective slots within the optical backplane and the switch is upgraded.

Unfortunately, even with the use of optical backplane technology, increasing the channel count for an N ports switch is a cumbersome task. To upgrade from a 32-channel N ports switch to a 40-channel N ports switch requires the addition of 8 new single channel N×N switches for the N ports. Also, N interface boards are replaced with N new interface boards to support the higher channel count. Thus, a total of N+8 boards are necessary to add and replace. Even when N is a small number such as 6, this results in replacement of 14 boards.

Also, prior art switches address wavelength channel upgradability within a port-based paradigm. Though, clearly from a technical perspective an upgrade is only achievable from input path to output path via the switch, the prior art architectures are such that a given port either supports switching within a particular wavelength channel or does not. Each port supporting switching of the particular wavelength channel is switchably connectable one to another. Software configuration is then used to prevent undesirable connections from forming.

For example, once two ports on an N×N switch support M channels, the remaining ports may support any number of channels up to M. Increasing a number of channels supported by the demultiplexer at any of the remaining ports allows that port to be upgraded—allows increased bandwidth between that port and other ports already supporting increased bandwidth. Since the architecture performs switching on all signals within a wavelength channel, the resulting switch is upgraded such that all ports supporting the increased number of channels can be switched with the newly upgraded port. Network flexibility is then supported through software design. Unfortunately, such architecture often results in hardware port-to-port couplings that are not desirable and are subsequently disabled. Since the hardware is the typical expense in network switches, this incurs additional and unnecessary costs.

In International Application WO 00/05832 to Huber, there is disclosed another switching architecture wherein light received at each of a plurality of input ports is demultiplexed, divided into separate optical paths, switchably attenuated within those paths, and then recombined and multiplexed to form an output signal at each of a plurality of output ports. The design of Huber supports high speed switching of optical signals within each of a plurality of different wavelengths within each of a plurality of different optical paths. Unfortunately, upgrading of a switch following the architecture of Huber is very difficult. The number of fibre connections required is significant. This is in part because, like other prior art switches, each wavelength channel optical signal is switched between an input port and all output ports as a basic building block of the switch.

It would be advantageous to provide a more flexible switching architecture.

### OBJECT OF THE INVENTION

In order to overcome these and other limitations of the prior art, it is an object of the present invention to provide a switch architecture supporting partial upgradability.

It is another object of the present invention to provide a switch architecture supporting asymmetric switches having different capabilities between different ports thereof.

It is a further object of the present invention to provide a switch architecture supporting redundancy within the switching fabric.

It is yet another object of the present invention to provide a switch architecture supporting broadcasting of optical data signals and full or partial redundancy one in conjunction with the other.

### SUMMARY OF THE INVENTION

In accordance with the invention there is provided an optical wavelength switch comprising:

a first port for receiving a first optical signal;

a second port for receiving a second optical signal;

a third port for receiving a third optical signal;

a first dedicated optical path between the first and second ports;

a third dedicated optical path between the first and third ports;

a first splitter at the first port for splitting the first optical signal into a first plurality of optical signals each comprising identical data and for directing one of the first plurality of optical signals along the first dedicated optical path and another of the first plurality of optical signals along the third dedicated optical path;

a first channel selective attenuator optically coupled within the first dedicated optical path for switchably varying the intensity of the first optical signal within each of a plurality of wavelength channels independently; and,

a third channel selective attenuator optically coupled within the third dedicated optical path for switchably varying the intensity of the first optical signal within each of a plurality of wavelength channels independently.

According to the invention there is also provided a method of upgrading an optical switch comprising the steps of:

providing a switch having a dedicated path coupling each port thereof and including first port for receiving an optical signal, a second port, and a channel selective attenuator for independently and selectively attenuating signals within each of a first number of wavelength channels; and,

replacing the channel selective attenuator with a channel selective attenuator for independently and selectively attenuating signals within each of a second number of wavelength channels different from the first number of wavelength channels.

According to the invention there is also provided a method of routing data within a network comprising a plurality of optical wavelength switches according to claim 1 wherein upon failure of a dedicated path from a first port to a destination port, optical data signals are routed to a port other than the first port or the destination port and then back into the switch via a port other than the first port and the destination port and therein routed to a destination port.

According to the invention there is also provided an optical wavelength switch comprising:

a first port for receiving a first optical signal and for directing it along at least two optical paths;

a second port for receiving a second optical signal and for directing it along at least two optical paths;

a third port for receiving a third optical signal and for directing it along at least two optical paths;

a first dedicated optical path between the first and second ports;

a second dedicated optical path between the second and third ports;

a third dedicated optical path between the first and third ports;

a first channel selective attenuator optically coupled within the first dedicated optical path for switchably varying the intensity of the first optical signal within each of a plurality of wavelength channels independently;

a second channel selective attenuator optically coupled within the second dedicated optical path for switchably varying the intensity of the second optical signal within each of a plurality of wavelength channels independently;

a third channel selective attenuator optically coupled within the third dedicated optical path for switchably varying the intensity of the first optical signal within each of a plurality of wavelength channels independently and,

a redundant port coupled to each of the first, second and third ports for supporting coupling of a redundant channel selective attenuator between any two of the first, second and third ports.

According to the invention there is also provided a method of reconfiguring an optical wavelength switch comprising the steps of:

providing an asymmetric optical wavelength switch having a plurality of switch input ports;

providing a switch coupled between a plurality of optical input ports and the switch input ports, the switch for switchably coupling optical signals received at the optical input ports to the switch input ports; and,

reconfiguring the switch to vary the coupling between switch input ports and optical input ports.

According to the invention there is also provided an optical wavelength switch comprising:

an optical cross connect having a 6 input ports and 6 output ports;

a first channel selective attenuator optically coupled between first two of the 6 output ports for switchably varying the intensity of an optical signal propagating between the first two of the 6 output ports within each of a plurality of wavelength channels independently;

a second channel selective attenuator optically coupled between second two of the 6 output ports for switchably varying the intensity of an optical signal propagating between the second two of the 6 output ports within each of a plurality of wavelength channels independently;

a third channel selective attenuator optically coupled between third two of the 6 output ports for switchably varying the intensity of an optical signal propagating between the third two of the 6 output ports within each of a plurality of wavelength channels independently;

a first splitter coupled with a first two ports of the 6 input ports for splitting a first received optical signal into a first plurality of optical signals each comprising identical data and for directing one of the first plurality of optical signals along a first of the first two ports and for directing one of the first plurality of optical signals along a second of the first two ports;

a second splitter coupled with a second two ports of the 6 input ports for splitting a second received optical signal into a second plurality of optical signals each comprising identical data and for directing one of the second plurality of optical signals to a first of the second two ports and for directing one of the second plurality of optical signals to a second of the second two ports; and,

a third splitter coupled with a third two ports of the 6 input ports for splitting a third received optical signal into a third plurality of optical signals each comprising identical data and for directing one of the third plurality of optical signals to a first of the third two ports and for directing one of the second plurality of optical signals to a second of the third two ports.

According to the invention there is also provided a method of upgrading an optical switch comprising the steps of:

providing a switch having a dedicated path coupling each port thereof and including first port for receiving a first optical signal, a second port for receiving a second optical signal, a redundant port for receiving one of the first and second optical signal, and three channel selective attenuators for independently and selectively attenuating signals within each of a first number of wavelength channels within each of the optical paths from the first port to the second port, from the first port to the third port, and from the second port to the third port;

upon detection of a failure in the optical path between the first and the second ports, switching the first optical signal to the redundant port,

wherein in use a signal received at the first port is couplable to the second port even when the optical path between the first and second port is damaged.

### BRIEF DESCRIPTION OF THE DRAWINGS

The invention will now be described with reference to the drawings in which:

FIG. 1 is a simplified prior art diagram of an N×N non-blocking switch;

FIG. 2 is a simplified prior art block diagram of a four-wavelength channel N×N non-blocking optical wavelength switch;

FIG. 3 is a simplified block diagram of an optical wavelength switch supporting 4 wavelength channels according to the invention;

FIG. 4 is a simplified block diagram of an asymmetric optical wavelength switch having one path supporting 8 channels;

FIG. 5 is a simplified block diagram of a an asymmetric optical wavelength switch having three paths supporting 8 channels;

FIG. 6 is a simplified network diagram having 12 network ports each coupled via the network;

FIG. 7 is a simplified network diagram having a similar configuration to that of FIG. 6;

FIG. 8 is a simplified network diagram having a similar configuration to that of FIG. 6;

FIG. 9a shows a network configuration supporting switching fabric redundancy and fault tolerance;

FIG. 9b and FIG. 9c show a further network configuration supporting switching fabric redundancy and fault tolerance;

FIG. 10a is a simplified block diagram of a switch having additional switchable paths for use in forming redundant dedicated paths within the switching fabric;

FIG. 10b is a simplified block diagram of a switch having additional couplings for use in forming redundant dedicated paths within the switching fabric;

FIG. 11a is a simplified block diagram of a switching fabric providing for redundancy through a use of additional switching fabric ports;

FIG. 12 is a simplified block diagram of a switching fabric featuring a redundant port and a series of optical switches configured to allow the bypassing of any port within the switching fabric;

FIG. 13 is a simplified block diagram of a switching fabric including a cross connect for providing redundancy; and,

FIG. 14 is a simplified block diagram of a switching fabric featuring an optical cross connect used with a switching fabric of the present invention to provide a highly configurable switching fabric.

### DETAILED DESCRIPTION OF THE INVENTION

In the following description and claims that follow, the following terms are defined as:

Port—an input or output interface for an optical component through which light enters or exits the optical component in use; and,

Channel selective attenuator is an optical component for performing at least one of amplifying or attenuating optical signals within different optical wavelength channels independently.

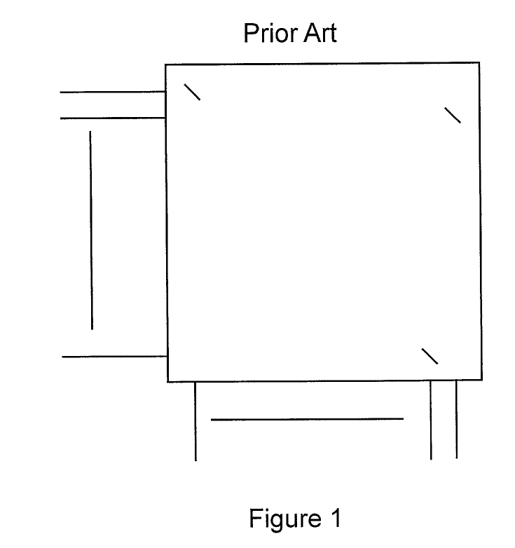

Referring to FIG. 1, a prior art N×N non-blocking switch is shown. As shown, each of the N input ports is optically couplable with each of the N output ports. Of course, the switch is for switching optical signals received at each of the N input ports selectably to the N output ports. Switches of this type are optionally mechanical in nature but need not be so.

When a network includes multiplexed optical signals at different wavelengths, a switch such as that shown in FIG. 1, is useful for switching the entire multiplexed signals. When individual signals within individual wavelength channels and multiplexed within a same optical waveguide are to be switched independently, the switch of FIG. 1 in isolation is insufficient.

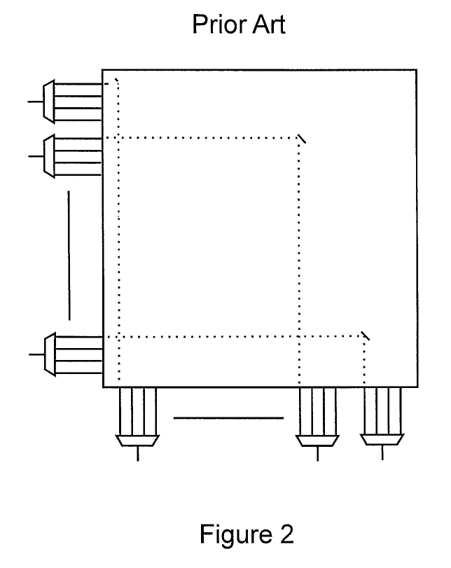

Referring to FIG. 2, an N×N non-blocking optical wavelength switch is shown where four optical signals within different wavelength channels are multiplexed in each of the N optical fibres. Here, each fibre is coupled to a demultiplexer; the four output ports of the demultiplexer are each coupled to a separate N×N non-blocking switch. This requires N connections—one to each demultiplexer, 4N connections from each demultiplexer to switches, and 4N connections from the switches to each multiplexer. Since the demultiplexers are bi-directional, the connections support switching between the N input ports for each of the four wavelengths.

When another signal at another wavelength is to be added, either the entire switch is replaced or else an additional component to handle the additional wavelength is used wherein an optical signal at the additional wavelength is demultiplexed from the multiplexed optical signal and then provided to an alternative switching fabric for switching thereof. This is the case even when the new signal is only intended to be switched between a subset of the N output ports. Also, removing and replacing any of the components of the switch requires significant time and expense in coupling together the optical demultiplexers/switches. Thus, maintenance of the switch is a costly process when necessary.

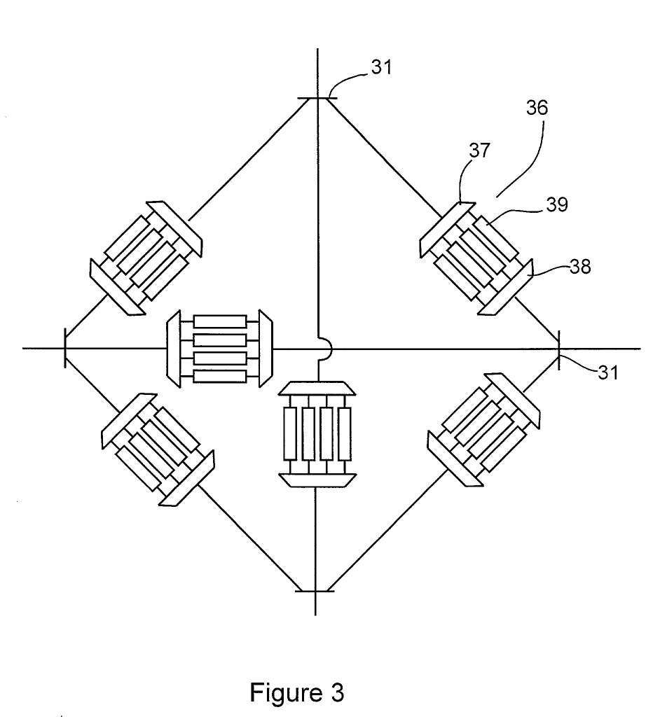

Referring to FIG. 3, a switch architecture according to the invention is shown in block diagram. The optical wavelength switch shown is a 4×4(N=4) switch. Each of the four input ports is coupled to a star coupler 31 dividing a signal propagating into the input port into N−1 or 3, optical paths. Each of the three signals is then provided to a channel selective attenuator 36 for attenuating and/or amplifying each individual signal independently. The signals are provided in a multiplexed fashion from the channel selective attenuator to a star coupler of another port.

As shown in FIG. 3, the channel selective attenuator 36 comprises a demultiplexer 37 for separating the optical signal into signals within each of a plurality of wavelength channels. Each signal propagates along a separate guided optical path. Each separate signal propagates along an independent path through an amplifier attenuator 39. The amplifier attenuator 39 acts to selectively pass signals within wavelength channels independently and, optionally, to amplify some of those signals. As shown, each amplifier attenuator acts on a single signal within a single wavelength channel to pass or block that signal. Alternatively, the amplifier attenuator is for attenuating optical signals within different optical paths.

When the amplifier attenuator 39 comprises a shutter, optical signals within each of the N independent paths, one for each wavelength channel, are selectably blocked. The channel selective attenuator 36 also includes a multiplexer 38 for recombining signals within wavelength channels that are other than blocked to form a single multiplexed signal. Of course, other forms of the channel selective attenuator are usable with the present invention in so far as they support the functionality required therefor.

Analysis of the switching architecture of FIG. 3 shows that the interport communication medium between two ports is a dedicated optical path having selectable shuttering, attenuation, or amplification therein. Because each path receives a single multiplexed signal and provides a single multiplexed signal and because a same signal is broadcasted into each path coupled to a same port, it is possible to have some ports in communication one with another and different other ports in communication one with another all within a same wavelength channel. For example, one port may have routing—dedicated optical paths—to 1 possible output port while another has routing—dedicated optical paths—to 2 possible output ports. Also, one dedicated path may support a larger number of wavelength channels than another.

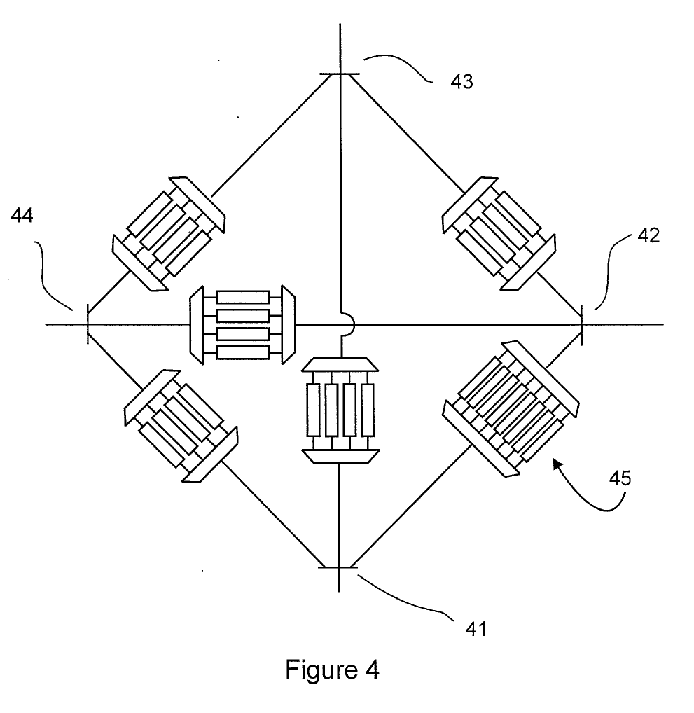

Referring to FIG. 4, another physical embodiment of the switch architecture is shown wherein the optical wavelength switch is asymmetric. Here, the first and second ports 41, 42 have a dedicated optical path therebetween for supporting 8 channels while the third and forth ports 43 and 44 have dedicated paths therefrom for supporting only 4 channels. As is evident, only the channel selective attenuator within the path 45 is different to provide the different functionality between the ports. Thus, the resulting system has a single modified component to support the increased channel count between the two ports over the embodiment of FIG. 3. Further, since upgrading of the optical wavelength switch is performed by replacing the channel selective attenuator, only two optical connections are made for an upgrade from the optical wavelength switch of FIG. 3 to the optical wavelength switch of FIG. 4.

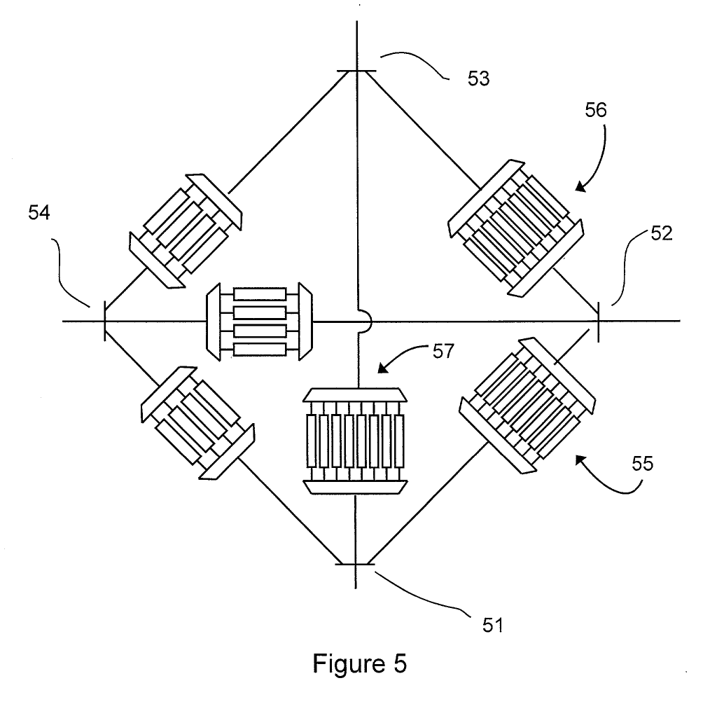

Referring to FIG. 5, another physical embodiment of the switch architecture is shown wherein the optical wavelength switch is asymmetric. Here, the first, second and third ports 51, 52, and 53 have dedicated paths therebetween supporting 8 channels while the forth port 54 has dedicated paths therefrom supporting only 4 channels. As is evident, only the channel selective attenuators 55, 56, and 57 are different for the three paths. Thus, the resulting system has a single modified component for each port-to-port upgrade resulting in three upgraded components 55, 56, and 57 to support the increased channel count between the three ports. Further, since upgrading of the optical wavelength switch is performed by replacing the channel selective attenuators, only six optical connections are made for an upgrade from the optical wavelength switch of FIG. 3 to the optical wavelength switch of FIG. 5.

This flexibility and architecture allows any single optical signal within a given wavelength channel to be directed to any of the output ports as design requirements specify. The architecture supports port-to-port restrictions without requiring that expensive hardware within the switching fabric be disabled. This design provides the option of simultaneously broadcasting a signal to all of the output ports, some of the output ports or none of the output ports. Preferably, each channel selective attenuator includes an amplifier to ensure signal power levels of the routed signals are sufficient for a wide variety of design purposes. Also preferably, each channel selective attenuator includes an attenuator to ensure that some optical signals can be blocked to avoid interference between optical signals at an output port.

In order to upgrade the optical wavelength switch of FIG. 4 to an optical wavelength switch having 3 dedicated paths supporting the increased channel count of 8 channels as shown in FIG. 5, only two channel selective attenuators are replaced. Thus, the resulting system has two modified components to support the increased channel count between the three ports. Further, since upgrading of the optical wavelength switch is performed by replacing the channel selective attenuators, only four optical connections are made for the upgrade from the optical wavelength switch of FIG. 4 to the optical wavelength switch of FIG. 5.

The architecture of the switching fabric of FIG. 4 is highly advantageous. Though it may appear that mixing N channel optical signals and M channel optical signals within a same optical wavelength switch is problematic, this is typically not the case. Though in the past, this was achieved using symmetric optical wavelength switches supporting more switching capabilities than necessary, it has been found that using the exact capabilities necessary suffices. For example, in a 4-channel network architecture, only 4 channels are supported. Any data transmitted at a wavelength outside of the 4 channels is filtered by receivers within the network and therefore poses no real problem to the network. Thus, when two optical wavelength switches are upgraded within a network to support 8 wavelength channels, increased communication bandwidth between those two optical wavelength switches is possible. All components other than the channel selective attenuators in the network should, optimally, pass on signals at those wavelengths that are outside of the communication channels without significant attenuation.

Thus, it is possible to increase the bandwidth between selected network ports without upgrading every optical wavelength switch within the network or every network interface port within the network. This is highly advantageous.

Alternatively, each channel selective attenuator attenuates all optical signals outside of the bandwidth of the channel selective attenuator.

Some further advantages to the switching architecture of the present invention are discussed below with reference to a network architecture comprising four 5-port switches coupled together to form a network. Advantageously, the switching architecture supports complex network routing including fault tolerant network topologies to allow for fault tolerant operation of switching within the network without requiring fault tolerant switching elements.

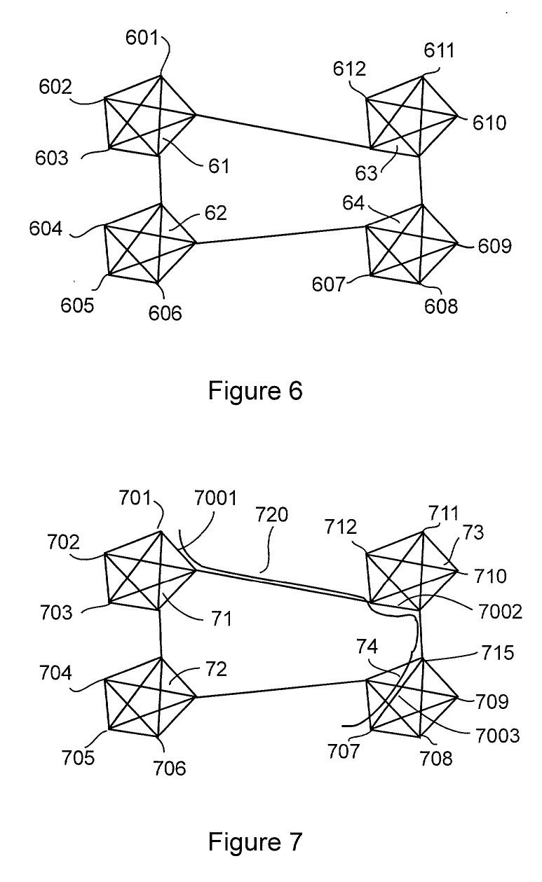

Referring to FIG. 6, a simplified network diagram is shown with 12 network interface ports 601 . . . 612 each coupled through a five-port optical wavelength switch 61, 62, 63, and 64. Each optical wavelength switch is coupled to two other five-port optical wavelength switches providing interswitch communication. This results in a network having 12 network interface ports. In the diagram of FIG. 6, each communication path supports 16 channels.

Referring to FIG. 7, a simplified network diagram is shown with 12 network interface ports 701 . . . 712 in a similar configuration to those of FIG. 6. Network interface ports 701 and 707 have equipment supporting transmission and reception of signals within each of 40 wavelength channels whereas the other network interface ports have equipment supporting transmission and reception of signals within each of only 16 wavelength channels. By upgrading each dedicated path 7001, 7002, and 7003, now a communication path 720 from port 701 to port 707 exists supporting the increased number of wavelength channels. This allows communication from port 701 to port 707 on any or all of the 40 wavelength channels. The resulting network hardware is mostly unchanged with the exception of the dedicated paths following the path 720 between the two ports 701 and 707. Because determining a path between two ports is not a complicated task, this architecture simplifies network-planning tasks. In FIG. 7, the path between the network interface ports 701 and 707 is indicated by the line 720. As is seen in the diagram of FIG. 7, only 3 dedicated paths require upgrading.

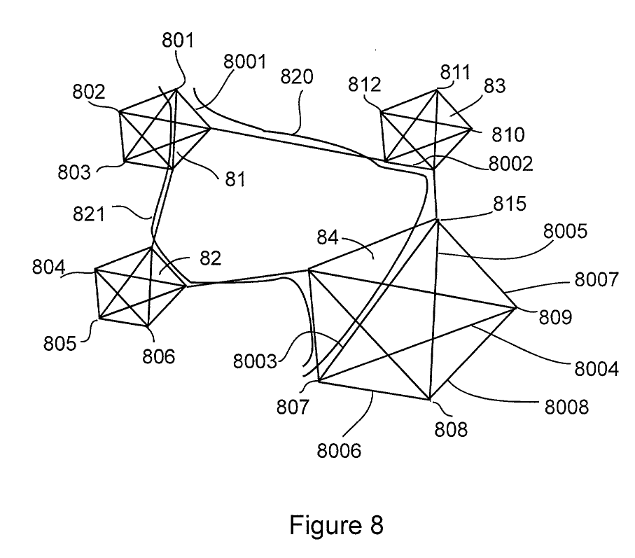

Referring to FIG. 8, a simplified network diagram is shown with 12 network interface ports 801 . . . 812 in a similar configuration to those of FIG. 6. Network interface ports 801 and 807 have equipment supporting transmission and reception of signals within each of 40 wavelength channels as do network interface ports 808, and 809; the other network interface ports have equipment supporting transmission and reception of signals within each of only 16 wavelength channels. The resulting network has more dedicated optical paths that must support 40 wavelength channels than the network of FIG. 7. By upgrading each dedicated path 8001, 8002, 8003, 8004, 8005, 8006, 8007, and 8008, now communication paths from port 801 to ports 807, 808, and 809 exist with dedicated optical paths therealong for supporting the increased number of wavelength channels. This allows communication from port 801 to each of ports 807, 808, and 809 on any or all of the 40 wavelength channels. Also, the dedicated paths between ports 807, 808, and 809 are upgraded to support communication therebetween within any of the 40 wavelength channels. Here, from port 808 to port 807 is one dedicated path that supports 40 channels. Also, the dedicated paths from 809 to 807, from 808 to 809, from 808 to the port 815 and from 809 to the port 815 support 40 wavelength channels.

When a second optical route between ports is available, such as that shown by way of arrow 821, upgrading of that optical path allows for redundancy in network communication between those ports while also enhancing the network for potential future bandwidth requirements.

Thus, the architecture herein described provides for a piecewise upgradable optical wavelength switch and network architecture that enhances network flexibility and decreases overall cost of network maintenance and growth.

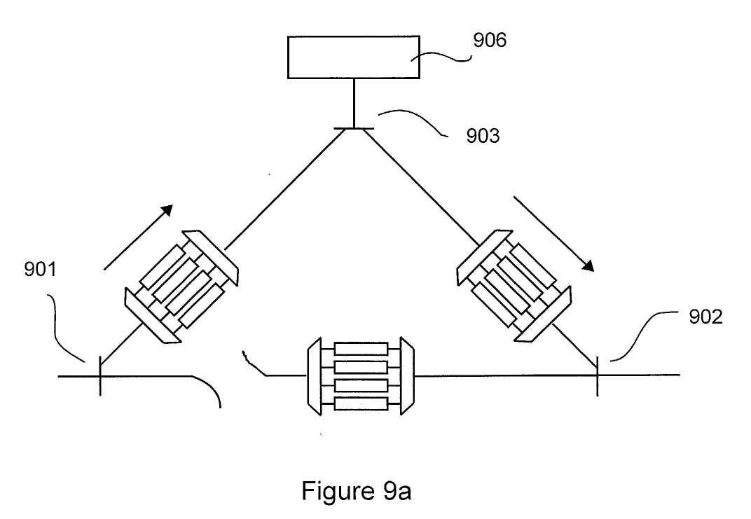

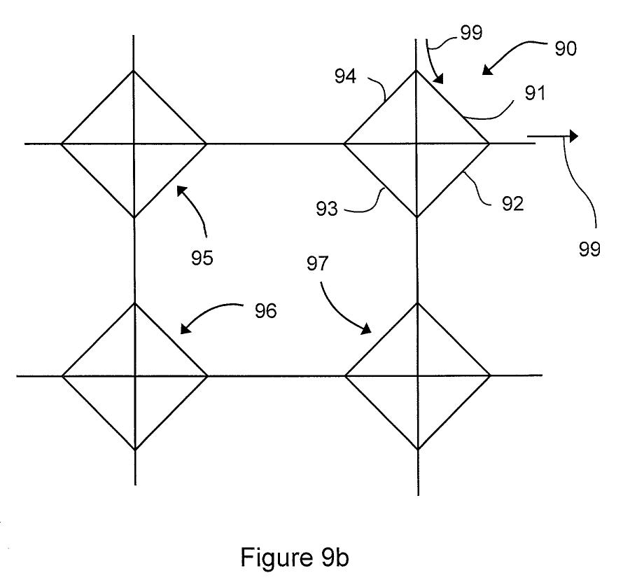

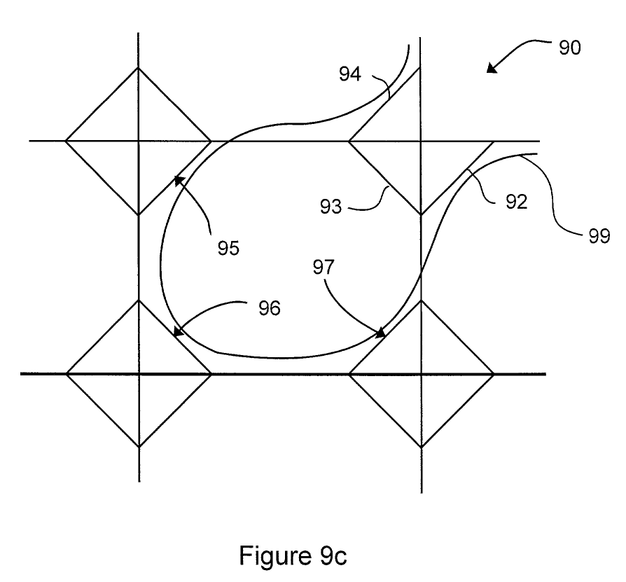

Referring to FIG. 9a, advantageously, a switching fabric according to the invention remains functional when a dedicated path between a first port 901 and a second port 902 is not available. Such unavailability may be due to design, damage or service requirements for upgrading the switching fabric. When this condition exists, it is possible to use a third port 903 to connect the first and second ports. To do this, an optical signal propagates from the first port 901 to the third port 903 of the switching fabric. The optical signal propagates out of the switching fabric and is reflected by a reflective element 906 in the form of a mirror or other means. The signal propagates from the third port to the second port 902 of the switching fabric, to which it was originally destined. While this example suggests using a third port 903, this technique is usable with any number of ports. Of course, because the switching fabric comprises dedicated optical paths, failure of a single path is not equivalent to failure of a port or of switching for an entire wavelength channel.

More particularly, since the dedicated optical paths operate to attenuate signals at wavelengths that are not to be routed through the switching fabric, even in the presence of a sudden and unexpected path failure it is possible to reroute signals from a source port to a port other than a destination port for re-routing via other dedicated optical paths to their destination. Of course, with a single failed dedicated path, only a single extra port is necessary to route all data to its intended destination.

Referring to FIG. 9b, a network topology is shown. Here, each dedicated path such as those shown at 91, 92, 93, and 94 is a sole coupling between ports within a same optical wavelength switch 90. That said, the optical wavelength switches are arranged such that, as shown in FIG. 9c, when an inter port dedicated path 91 of a single optical wavelength switch is damaged or temporarily unavailable, data is routable via the switching network out of the single optical wavelength switch 90 to other optical wavelength switches 95, 96, and 97 and then back to the single optical wavelength switch 90 through another different port to allow switching of the optical signal to the desired output port. This is shown by the routing line 99. Of course, such a network topology also supports additional bandwidth on demand and so forth. Thus, such an embodiment, when the network topology accommodates it, allows for switching fabric upgrade without requiring the network to be inaccessible or placed in a service mode wherein communication is not fully supported.

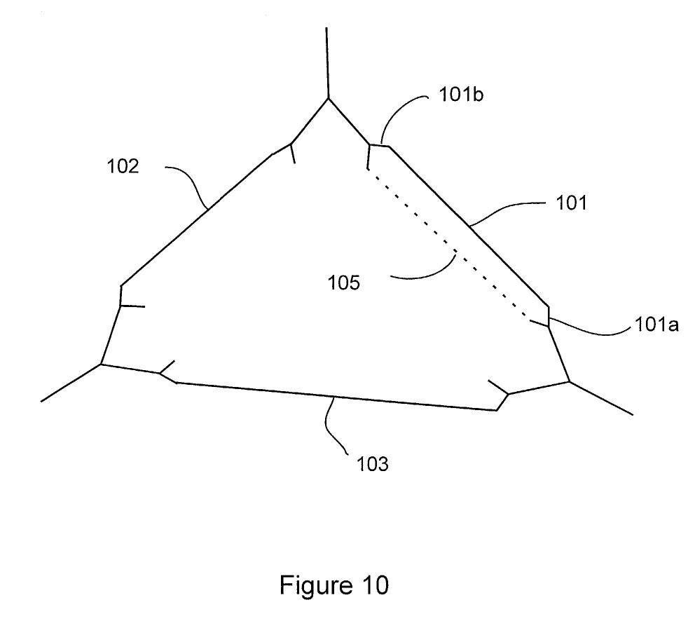

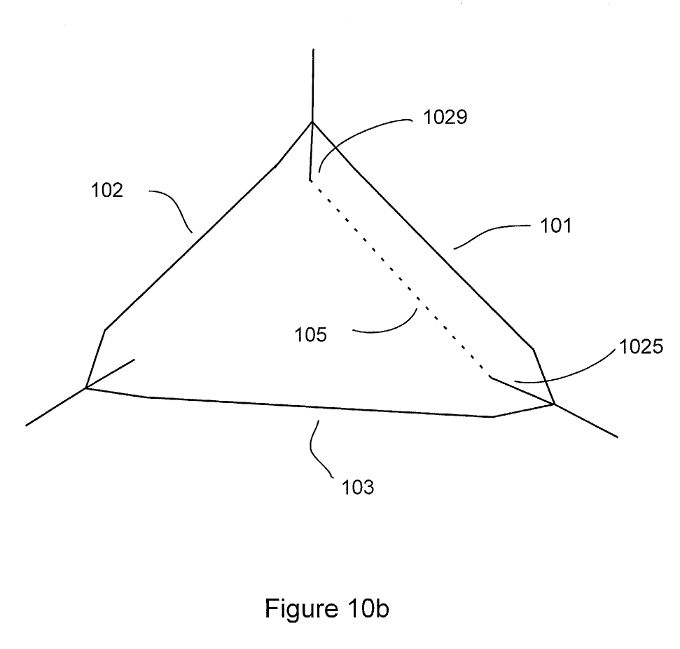

Another redundant switch architecture is shown in FIG. 10a. Here each dedicated path 101, 102, and 103 has a 1 to 2 switch, for example 101a and 101b, at either end. A new dedicated path element is couplable to unused ports on the switches 101a and 101b. This is shown in dashed line at 105. By actuating the switches, the optical signals are switched through the new dedicated path element allowing removal of the old dedicated path element. That is sufficient to perform an upgrade of a single dedicated optical path, though it is often desirable to return the switches to their resting state once the process is completed. When the new dedicated path element is permanently installed and comprises a channel selective attenuator supporting at least all the channels supported by the channel selective attenuators of the switch, then the new dedicated path is also useful for replacing failed dedicated paths during normal switch operation and for most maintenance operations of the switch. Of course, such a switch architecture is an N+N redundancy switch.

Referring to FIG. 10b, optionally, components used in a redundant path are temporary and provided by a service professional upgrading the switch fabric. In order to do this, it is required that the couplers for all of the ports in service have an extra unused port 1029 and 1025 for coupling a dedicated optical path therebetween. Thus, the redundant component 105 is inserted in parallel to path 101 as shown in dashed lines prior to an upgrade for path 101 and the switching software is notified of the change of dedicated path hardware to redundant component 105.

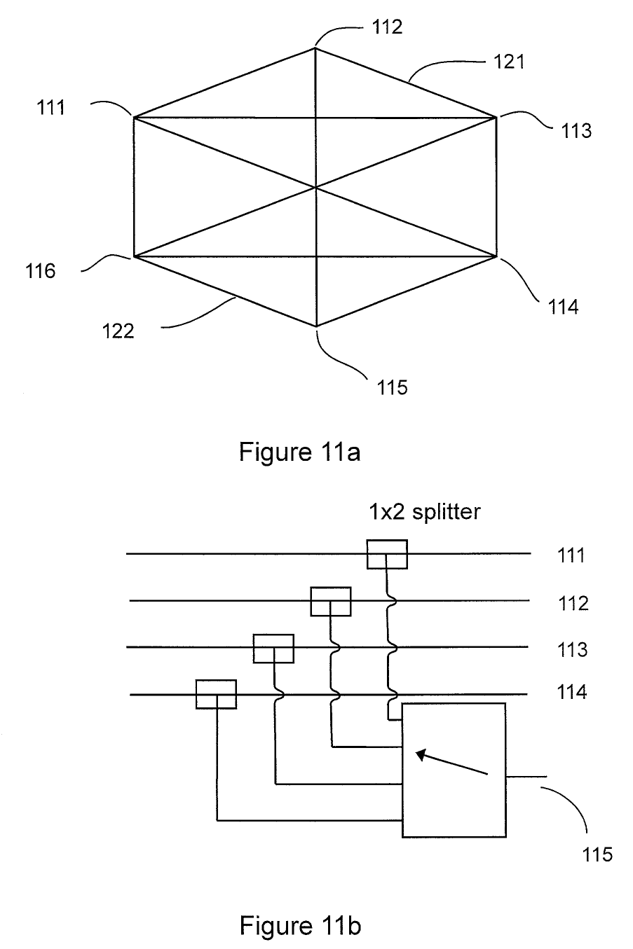

Yet another redundant switch architecture is shown in FIG. 11a. Here a switching fabric is shown having N+2 ports where N=4 and ports 115 and 116 are the two redundant ports. The two redundant ports are coupled through switches to every other port as shown for port 115 in FIG. 11b. Thus, to remove a dedicated path 121 from operation, the ports 113 and 112 are switched to the ports 115 and 116. Thus the dedicated path 122 functions as dedicated path 121. Now the elements within dedicated optical path 121 are upgradable, removable, replaceable, serviceable, etc. When the process of repair or upgrade is complete, the switches are returned to their normal configuration and the dedicated optical path 121 returns to normal operation.

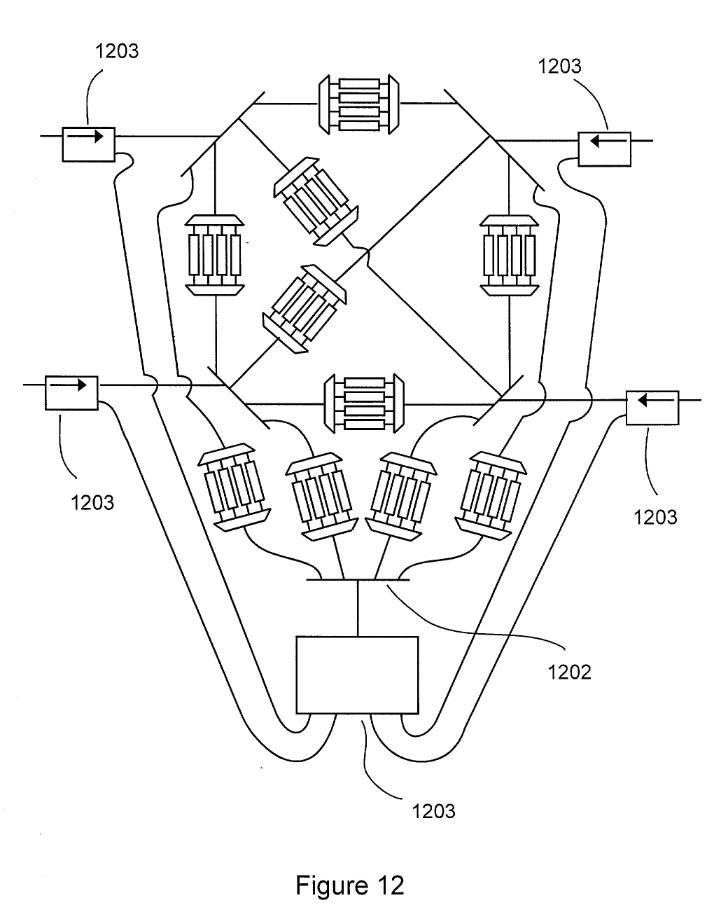

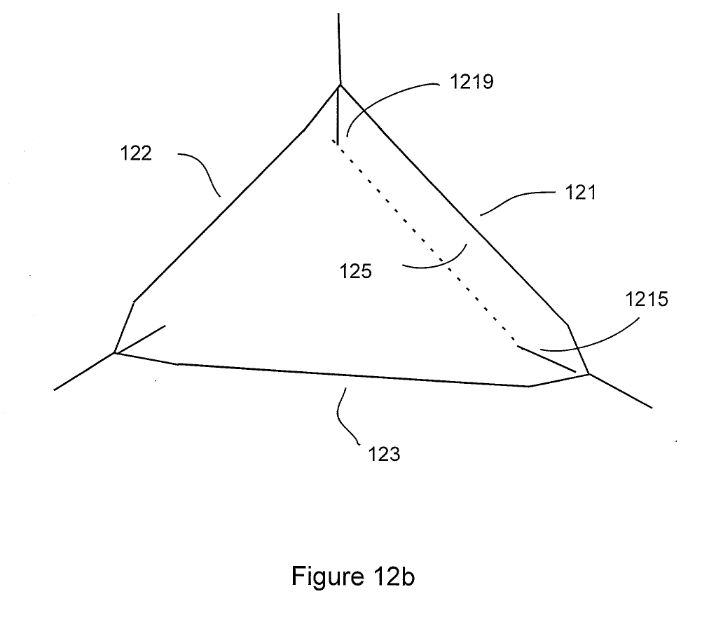

Of course, once a clear understanding of the N+2 port configuration is gained, it is evident that only N+1 ports are required to provide the same functionality. Referring to FIG. 12, in an application in which wavelength channel count upgrades are likely, the switch fabric is given an additional port 1202 referred to as a “redundant port”. Using prior art optical wavelength switches 1203, it is a simple matter to use switches to bypass any port and paths associated with that port. By triggering the switches, the path receiving maintenance is bypassed and paths coupled to the redundant port are used instead. The only disruption to the switching fabric is a time required to switch the switches. Thus, the entire fabric operates normally until the component repair or replacement is completed.

In the event that a plurality of paths is being upgraded, the optical switches are set to route optical signals away from the area where the upgrade is being performed for the time the upgrade is performed. Thus, a first set of dedicated paths from a first port are isolated and upgraded. Once this is completed, a set of dedicated paths from a second other port are isolated and upgraded and so forth until all desired path upgrades are completed. In this way it is a simple matter to upgrade the entire switch fabric one path at a time while only disrupting traffic on the switch fabric very briefly.

Alternatively, the extra port is used to add redundancy to the switch fabric and thereby compensate for any damage to a path or a plurality of paths from a same port by avoiding the damaged paths. This requires that the additional paths form part of the switch fabric. The enhanced switch fabric shown in FIG. 12 is only capable of diverting traffic away from one port at a time. In this application switches have been chosen to route the optical signals away from a port, for example a port receiving service, due to their low insertion loss and good isolation.

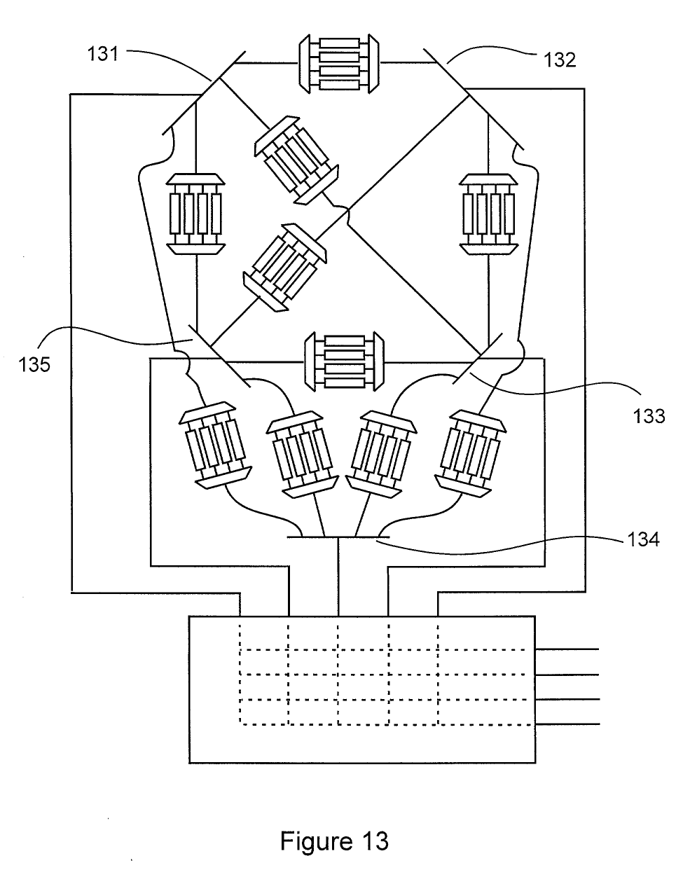

Referring to FIG. 13, a simplified block diagram of a switching fabric including an optical cross connect is shown. Here, the optical cross connect allows for switching of data signals within the switching fabric to any of the ports 131, 132, 133, 134, and 135. For a 4 port switch, as shown, this allows any of the input optical signals to be directed toward either their designated port or an alternative port supporting redundancy for each port. Should a port become damaged, the cross connect provides a simple and highly automated method of switching data signals received and destined for or through the damaged component to another undamaged dedicated optical path. Thus, a 5×5 switching fabric as described above is shown to support the 4×4 switching operation with full redundancy for failures occurring within any of the dedicated optical paths. Should one of the channel selective attenuators become inoperable the cross connect is useful in reconfiguring the switching fabric to support the new requirements. Also, when the switching fabric is asymmetric, some of the channel selective attenuators support more channels than others, the cross connect is useful in supporting reconfiguration of the switching fabric.

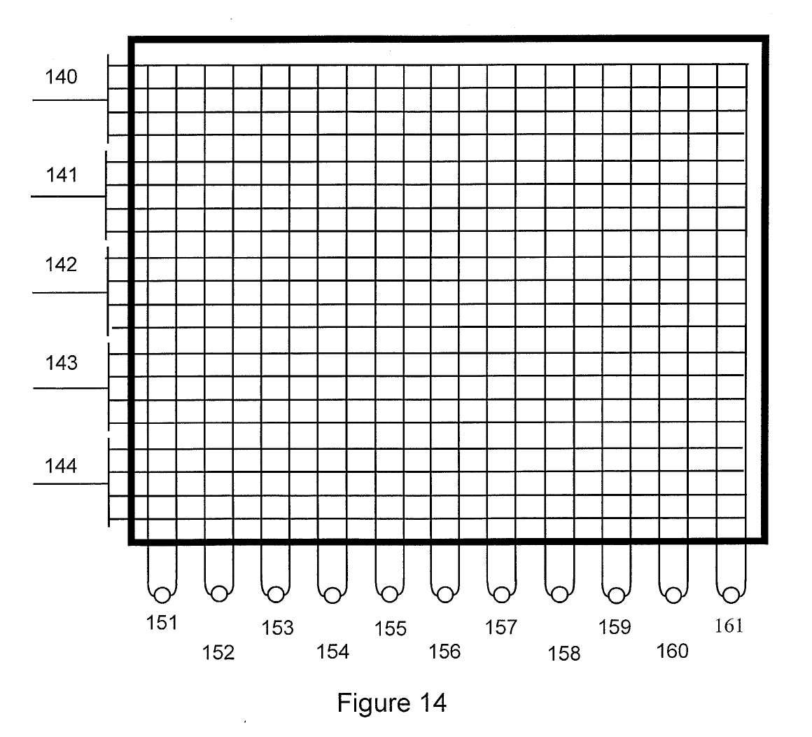

Referring to FIG. 14 a more configurable switch than that of FIG. 13 is shown. Here a 20×22 matrix switch is used with channel selective attenuators to form a 5×5 optical switch having a redundant dedicated optical path. This allows for each optical signal received at any of the input ports within the matrix switch to be routed via any of the dedicated optical paths. Here for simplicity, each channel selective attenuator is shown interfacing with the cross connect directly and this is a possible implementation. Though the diagram appears substantially different to that of FIG. 3, for example, in architecture, the switch is very similar having a plurality of dedicated optical paths each having a channel selective attenuator therein. A signal received at the port 140 is switchable to any of channel selective attenuators 151-161. The other side of the same channel selective attenuator is also switchable to couple it with any port. Thus a dedicated path can be formed between any two ports or even between a single port and itself. This flexibility, though useful for providing switching fabric redundancy, is highly advantageous for providing switching fabric reconfigurability.

Advantages are highlighted hereinbelow through two simple examples. First, assume a network has a plurality of users and that some users consume more bandwidth during the daytime, for example financial consumers, while others consume more bandwidth outside of daytime hours such as home based information access requests. Presently, a switching fabric is created supporting the sum of the maximum bandwidth requirements of each group, even though the total maximum bandwidth at any time is much smaller than this sum. Using the switching fabric of FIG. 14, it is possible to reconfigure the network between the two time periods in order to increase bandwidth to one consumer group or another. Thus, during the daytime, home based access requests may be provided with 4 wavelength channels of bandwidth while the financial consumers are provided with 80 wavelength channels of bandwidth. In the evening around 6:00 PM, the switching fabric is reconfigured to provide 80 channels of bandwidth to the home-based consumers and only 4 wavelength channels of bandwidth to the financial consumers. Thus, instead of 160 wavelength channels of bandwidth, only a total of 84 wavelength channels need to be supported by the switching fabric within each of two separate dedicated optical paths.

Another advantage realized by the architecture of FIG. 14 is that of a mass-produced configurable switching architecture. Here, an optical switching fabric is created supporting various bandwidths within various dedicated optical paths. The switching fabric is installed within a network and, at that time, is configured to best meet the network requirements. Of course, as network requirements change over time, the switching fabric is very flexible in reconfigurability to support the changing network needs. Such a switch thereby greatly facilitates network planning and other complex network management tasks.

Though the above noted examples refer to a generic switch, the channel selective attenuator is typically bi-directional and can support optical traffic propagating in opposing directions within different wavelength channels. When optical signals within a same wavelength channel propagate in opposite directions, the switch functions correctly though isolation issues and backreflections should be accounted for in switch design and configuration. Of course, the switching elements could be designed so as to be uni-directional in nature supporting communication therethrough in only one direction of propagation. Further optionally, between two ports there are provided two dedicated optical paths one for propagating an optical signal in a first direction and the other for propagating an optical signal in the other direction.

A channel selective attenuator includes for example a variable optical attenuator for adjusting an intensity of light propagating therethrough, a shutter for one of passing light and blocking light, and an amplifier for absorbing and/or amplifying light propagating therethrough. As such, depending on the selected channel selective attenuator components, the device is provided with additional or reduced functionality. For example, when the channel selective attenuator includes amplifiers, it is also possible to use it in performing power equalization.

Numerous other embodiments may be envisaged without departing from the spirit or scope of the invention.

What is claimed is:

1. An optical wavelength switch comprising:
a first port for receiving a first optical signal;
a second port for receiving a second optical signal;
a third port for receiving a third optical signal;
a first dedicated optical path between the first and second ports;
a third dedicated optical path between the first and third ports;
a first splitter at the first port for splitting the first optical signal into a first plurality of optical signals each comprising identical data and for directing one of the first plurality of optical signals along the first dedicated optical path and another of the first plurality of optical signals along the third dedicated optical path;
a first channel selective attenuator optically coupled within the first dedicated optical path for switchably varying the intensity of the first optical signal within each of a plurality of wavelength channels independently; and,
a third channel selective attenuator optically coupled within the third dedicated optical path for switchably varying the intensity of the third optical signal within each of a plurality of wavelength channels independently.

2. An optical wavelength switch according to claim 1 wherein the channel selective attenuator is a channel selective amplifier attenuator.

3. An optical wavelength switch according to claim 1 wherein the first dedicated optical path includes the first channel selective attenuator and wherein the channel selective attenuator is coupled within the first dedicated optical path by optical couplings consisting of a first optical coupling and a second optical coupling.

4. An optical wavelength switch according to claim 1 wherein the first channel selective attenuator includes a demultiplexer for separating the first signal into separate signals within different wavelength channels, a plurality of attenuators each disposed for receiving one of the separate signals and for selectively attenuating the separate signals within each of the wavelength channels independently, and a multiplexer disposed for receiving the selectively attenuated signals and for combining the attenuated signals into a single optical waveguide along the first dedicated optical path.

5. An optical wavelength switch according to claim 4 wherein the plurality of attenuators includes a plurality of amplifier attenuators each disposed for receiving one of the separate signals and for selectively amplifying/attenuating the separate signals within each of the wavelength channels independently.

6. An optical wavelength switch according to claim 4 wherein the third channel selective attenuator includes a demultiplexer for separating the first signal into separate signals within different wavelength channels, a plurality of attenuators each disposed for receiving one of the separate signals and for selectively attenuating the separate signals within each of the wavelength channels independently, and a multiplexer disposed for receiving the selectively attenuated signals and for combining the attenuated signals into a single optical waveguide along the third dedicated optical path.

7. An optical wavelength switch according to claim 1 wherein the first channel selective attenuator includes an amplifier.

8. An optical wavelength switch according to claim 1 wherein the first channel selective attenuator is absent an amplifier.

9. An optical wavelength switch according to claim 7 wherein the first channel selective attenuator includes a demultiplexer for separating the first signal into separate signals within different wavelength channels, a plurality of amplifier attenuators each disposed for receiving one of the separate signals and for selectively amplifying/attenuating the separate signals within each of the wavelength channels independently, and a multiplexer disposed for receiving the amplified/attenuated signals and for combining the amplified/attenuated signals into a single optical waveguide along the first dedicated optical path.

10. An optical wavelength switch according to claim 9 wherein only those of the separate signals that are other than attenuated are amplified.

11. An optical wavelength switch according to claim 1 comprising:
a second dedicated optical path between the second and third ports;
a second splitter at the second port for splitting the second optical signal into a second plurality of optical signals each comprising identical data and for directing one of the second plurality of optical signals along the second dedicated optical path and another of the first plurality of optical signals along the first dedicated optical path; and,
a second channel selective attenuator optically coupled within the second dedicated optical path for switchably varying the intensity of the second optical signal within each of a plurality of wavelength channels independently.

12. An optical wavelength switch according to claim 11 comprising:
a third splitter at the third port for splitting the third optical signal into a third plurality of optical signals each comprising identical data and for directing one of the third plurality of optical signals along the third dedicated optical path and another of the third plurality of optical signals along the first dedicated optical path

13. An optical wavelength switch according to claim 1 wherein the first channel selective attenuator is for independently and selectively attenuating signals within each of a number of wavelength channels different from the number of wavelength channels in which the third channel selective attenuator is for independently and selectively attenuating signals.

14. An optical wavelength switch according to claim 1 comprising:
a first redundant port for receiving the first optical signal;
a second redundant port for receiving the second optical signal;
a third redundant port for receiving the third optical signal;
a first switch for guiding light to at least one of the first port and the first redundant port;
a second switch for guiding light to at least one of the second port and the second redundant port; and
a third switch for guiding light to at least one of the third port and the third redundant port,
wherein further dedicated optical paths are formable from the redundant ports to provide for switching redundancy.

15. An optical wavelength switch according to claim 14 comprising:
a fourth port coupled to the first redundant port for receiving a first optical signal;
a fifth port coupled to the second redundant port for receiving a second optical signal;
a fourth dedicated optical path between the fourth and fifth ports; and,
a fourth channel selective attenuator optically coupled within the fourth dedicated optical path for switchably varying the intensity of the first optical signal within each of a plurality of wavelength channels independently.

16. An optical wavelength switch according to claim 14 comprising:
a second optical wavelength switch including:
a fourth port coupled to the first redundant port for receiving a first optical signal;
a fifth port coupled to the second redundant port for receiving a second optical signal;
a sixth port coupled to the third redundant port for receiving a third optical signal;
a fourth dedicated optical path between the fourth and fifth ports;
a fifth dedicated optical path between the fourth and sixth ports;
a fourth channel selective attenuator optically coupled within the fourth dedicated optical path for switchably varying the intensity of the first optical signal within each of a plurality of wavelength channels independently; and,
a fifth channel selective attenuator optically coupled within the sixth dedicated optical path for switchably varying the intensity of the first optical signal within each of a plurality of wavelength channels independently.

17. An optical wavelength switch according to claim 1 comprising:
a reflector;
a redundant port coupled to the reflector; and
dedicated paths from each of the first, second, and third ports to the redundant port, the dedicated paths each including a channel selective attenuator for switchably varying the intensity of an optical signal within each of a plurality of wavelength channels independently.

18. An optical wavelength switch according to claim 1 comprising:
a first redundant port for receiving the first optical signal;
a redundant port switch for guiding light to at least one of the first port and the first redundant port, for guiding light to at least one of the second port and the first redundant port, and for guiding light to at least one of the third port and the first redundant port,
wherein further dedicated optical paths are formable from the redundant port to provide for switching redundancy.

19. An optical wavelength switch according to claim 18 comprising:
a redundant channel selective attenuator optically coupled between two redundant ports for switchably varying the intensity of an optical signal within each of a plurality of wavelength channels independently.

20. An optical wavelength switch according to claim 18 wherein the redundant port switch comprises a plurality of 1×2 switches, one at each of the first, second and third ports and a coupler for coupling one of the two output ports of the 1×2 switches to the redundant port.

21. An optical wavelength switch according to claim 18 wherein the redundant port switch comprises a plurality of 1×2 splitters, one at each of the first, second and third ports and a N×1 switch for coupling one and only one of the two output ports of the 1×2 splitters to the redundant port.

22. An optical wavelength switch according to claim 18 wherein the redundant port switch comprises a cross connect for routing any of the first, second and third optical signals to any of the first port, the second port, the third port and the redundant port.

23. An optical wavelength switch according to claim 22 wherein the optical cross connect is coupled to the first port, the second port, the third port, and the redundant port on an output port side of the optical cross connect and is coupled to a plurality of input waveguides for providing optical input signals to the cross connect on an input port side thereof, the cross connect for, in use, routing any of the plurality of optical input signals to any of the first port, the second port, the third port, and the redundant port.

24. An optical wavelength switch according to claim 23 comprising:
a plurality of channel selective attenuators, each disposed within an optical path between two of the first port, the second port, the third port and the redundant port for providing at least a dedicated path between each two of the first port, the second port, the third port and the redundant port.

25. A method of upgrading an optical switch comprising the steps of:
providing a switch having a dedicated path coupling each port thereof and including a first port for receiving an optical signal, a second port, and a channel selective attenuator for independently and selectively attenuating signals within each of a first number of wavelength channels; and,
replacing the channel selective attenuator with a channel selective attenuator for independently and selectively attenuating signals within each of a second number of wavelength channels different from the first number of wavelength channels.

26. A method according to claim 25 wherein the channel selective attenuator receives a single multichannel optical signal and provides at an output thereof a single multichannel optical signal and wherein light within wavelength channels are selectably and independently attenuated therein.

27. A method according to claim 26 wherein the channel selective attenuator comprises a multiplexer, a demultiplexer and a plurality of attenuators each for attenuating light within an optical path of a demultiplexed optical signal.

28. A method according to claim 26 wherein the channel selective attenuator comprises a multiplexer, a demultiplexer, a plurality of attenuators each for attenuating light within an optical path of a demultiplexed optical signal, and at least an amplifier.

29. A method according to claim 27 wherein the channel selective attenuator comprises a plurality of amplifiers each for amplifying light within an optical path of a demultiplexed optical signal and wherein signals are one of attenuated and amplified.

30. A method according to claim 29 wherein the attenuators and the amplifiers form amplifier attenuators and in conjunction with each other and with the multiplexer and demultiplexer form a channel selective attenuator.

31. A network including a plurality of optical wavelength switches according to claim 1.

32. A method of routing data within a network comprising a plurality of optical wavelength switches according to claim 1 wherein upon failure of a dedicated path from a first port to a destination port, optical data signals are routed to a port other than the first port and the destination port and then back into the switch via a port other than the first port and the destination port and therein routed to the destination port.

33. A method according to claim 32 wherein the optical data signals are routed out of the switch via the port other than the first port and the destination port to at least another switch and then back into the switch via the port other than the first port.

34. A method according to claim 32 wherein the port other than the first port and the destination port and the port other than the first port are a same port and wherein the same port is coupled to a reflector.

35. A method according to claim 34 wherein the same port is a redundant port for use in networking optical data signals during dedicated path failure.

36. A method of upgrading a network including a plurality of switches according to claim 1 comprising the steps of:
determining a path between two network interface ports, the two network interface ports having transceivers for transmitting and receiving optical data signals within an increased number of wavelength channels; and,
upgrading each channel selective attenuator within the determined path to a channel selective attenuator supporting the increased number of wavelength channels.

37. A method according to claim 36 wherein channel selective attenuators already supporting the increased number of channels are other than replaced.

38. A method according to claim 37 wherein the channel selective attenuators are channel selective amplifier attenuators.

39. A method according to claim 36 comprising the step of:
upgrading paths between network interface ports supporting the increased number of channels and the two network interface ports by replacing channel selective attenuators within those paths with channel selective attenuators supporting the increased number of channels.

40. An optical wavelength switch comprising:
a first port for receiving a first optical signal and for directing it along at least two optical paths;
a second port for receiving a second optical signal and for directing it along at least two optical paths;
a third port for receiving a third optical signal and for directing it along at least two optical paths;
a first dedicated optical path between the first and second ports;
a second dedicated optical path between the second and third ports;
a third dedicated optical path between the first and third ports;
a first channel selective attenuator optically coupled within the first dedicated optical path for switchably varying the intensity of the first optical signal within each of a plurality of wavelength channels independently;
a second channel selective attenuator optically coupled within the second dedicated optical path for switchably varying the intensity of the second optical signal within each of a plurality of wavelength channels independently;
a third channel selective attenuator optically coupled within the third dedicated optical path for switchably varying the intensity of the third optical signal within each of a plurality of wavelength channels independently; and,
a redundant port coupled to each of the first, second and third ports for supporting coupling of a redundant channel selective attenuator between any two of the first, second and third ports.

41. An optical wavelength switch according to claim 40 wherein the redundant port is switchably coupled to the first port.

42. An optical wavelength switch according to claim 41 wherein the redundant port is switchably coupled to each of the first, second and third ports.

43. An optical wavelength switch according to claim 41 wherein the redundant port is one of a plurality of redundant ports coupled to each of the first, second and third ports, the plurality of redundant ports including a redundant port within each dedicated optical path.

44. A method of reconfiguring an optical wavelength switch comprising the steps of:
providing an asymmetric optical wavelength switch having a plurality of switch input ports;
providing a switch coupled between a plurality of optical input ports and the switch input ports, the switch for switchably coupling optical signals received at the optical input ports to the switch input ports; and,
reconfiguring the switch to vary the coupling between switch input ports and optical input ports.

45. An optical wavelength switch comprising:
an optical cross connect having 6 input ports and 6 output ports;
a first channel selective attenuator optically coupled between first two of the 6 output ports for switchably varying the intensity of an optical signal propagating between the first two of the 6 output ports within each of a plurality of wavelength channels independently;
a second channel selective attenuator optically coupled between second two of the 6 output ports for switchably varying the intensity of an optical signal propagating between the second two of the 6 output ports within each of a plurality of wavelength channels independently;
a third channel selective attenuator optically coupled between third two of the 6 output ports for switchably varying the intensity of an optical signal propagating between the third two of the 6 output ports within each of a plurality of wavelength channels independently;
a first splitter coupled with a first two ports of the 6 input ports for splitting a first received optical signal into a first plurality of optical signals each comprising identical data and for directing one of the first plurality of optical signals along a first of the first two ports and for directing one of the first plurality of optical signals along a second of the first two ports;
a second splitter coupled with a second two ports of the 6 input ports for splitting a second received optical signal into a second plurality of optical signals each comprising identical data and for directing one of the second plurality of optical signals to a first of the second two ports and for directing one of the second plurality of optical signals to a second of the second two ports; and,
a third splitter coupled with a third two ports of the 6 input ports for splitting a third received optical signal into a third plurality of optical signals each comprising identical data and for directing one of the third plurality of optical signals to a first of the third two ports and for directing one of the second plurality of optical signals to a second of the third two ports.

46. A switch according to claim 45 wherein each of the splitters is switchably couplable to each of the channel selective attenuators for providing reconfigurablity of the switch.

47. An optical wavelength switch according to claim 45 wherein the first channel selective attenuator is a channel selective amplifier attenuator.

48. An optical wavelength switch according to claim 45 wherein the optical cross connect comprises a fourth pair of output ports and comprising:
a redundant channel selective attenuator channel selective attenuator optically coupled between the fourth pair of output ports for switchably varying the intensity of an optical signal propagating between the output ports of the fourth pair within each of a plurality of wavelength channels independently.

49. A method of upgrading an optical switch comprising the steps of:
providing a switch having a dedicated path coupling each port thereof and including first port for receiving a first optical signal, a second port for receiving a second optical signal, a redundant port for receiving one of the first and second optical signal, and three channel selective attenuators for independently and selectively attenuating signals within each of a first number of wavelength channels within each of the optical paths from the first port to the second port, from the first port to the third port, and from the second port to the redundant port; and,
upon detection of a failure in the optical path between the first and the second ports, switching the first optical signal to the redundant port,
wherein in use a signal received at the first port is couplable to the second port even when the optical path between the first and second port is damaged.

50. A method according to claim 49 wherein the switch is coupled to a further optical switch for switching the first optical signal between the first port and the redundant port.

51. A method according to claim 49 wherein the channel selective attenuators comprise a multiplexer, a demultiplexer and a plurality of attenuators each for attenuating light within an optical path of a demultiplexed optical signal.

52. A method according to claim 51 wherein the channel selective attenuators comprise a plurality of amplifiers each for amplifying light within an optical path of a demultiplexed optical signal and wherein signals are one of attenuated and amplified.
